(19) United States
(12) Patent Application Publication
(10) Pub. No.: US 2006/0112749 A1
(43) Pub. Date: Jun. 1, 2006

(54) Soil amendment product and method of processing

(76) Inventors: Anthony P. Noll, Covington, KY (US); Herbert A. Ligon, Nashville, TN (US)

Correspondence Address: DYKAS, SHAVER & NIPPER, LLP, P.O. BOX 877, BOISE, ID, 83701-0877, US

(21) Appl. No.: 11/296,586

(22) Filed: Dec. 6, 2005

Related U.S. Application Data
(63) Continuation-in-part of application No. 10/713,557, filed on Nov. 13, 2003.

(51) Int. Cl. C05F 3/00

(52) U.S. Cl. 71/22

(57) ABSTRACT

A soil amendment product made from biomass, and a method of making a soil amendment product from biomass. The soil amendment is made by processing biomass in a pressurizable reaction vessel with heat, pressure and agitation.

### PRIORITY

This application is a continuation-in-part application which claims the priority date from the application entitled MSW PROCESSING VESSEL filed by Anthony Noll, et al., on Nov. 13, 2003 with application Ser. No. 10/713,557, the disclosure of which is incorporated herein by reference.

### DESCRIPTION

### Background of the Invention

1. Field of the Invention

The present invention generally relates to methods of processing MSW to produce a soil amendment, and more specifically to a process for making a soil amendment and soil conditioner from the biomass processed from MSW in a heated and pressurized system.

2. Background Information

The handling of municipal solid waste (MSW) is a growing problem in the industrialized countries of the world. The more industrialized a country is, the more MSW per capita is produced. At the same time, less land is available for permanent placement of the MSW. Environmental regulations are becoming increasingly strict, making operating a landfill increasingly expensive and difficult, further, they make opening a new landfill and closing an old one extremely expensive and difficult. All of these factors come together and make dealing with MSW a huge problem.

Any invention that reduces the amount of material that must be buried in landfills is a great benefit. Of even more benefit is an invention that turns a problematic waste stream, such as MSW, into a beneficial product.

One such beneficial product is a product that can be added to soil, which improves the quality of the soil. This can be called a soil conditioner, a soil amendment, an application, a conditioner, a mulch, a fiber additive, stabilizer, a feedstock or component of compost or other terms commonly used in the field of agriculture. The soil conditioner or amendment can be made using MSW as a feed source, and the process that produces the soil conditioner also significantly reduces the amount of MSW that must be placed in landfills. A great benefit to both the solid waste system and the world of agriculture can thus be obtained. This is one goal of this invention, to create a soil amendment or soil additive starting with the base material of municipal solid waste.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

These and other objects and goals are achieved by a method of processing an MSW feed stream into useful products, including a soil amendment or soil conditioner compound.

The invention is also a soil amendment composed of a cellulosic material, which starts as a biomass feed stream, and which is processed in the process of the invention, using a reaction vessel in the presence of heat, pressure and agitation. A reaction vessel that is suitable to achieve this purpose is that shown in U.S. patent application Ser. No. 10/703,557, which is incorporated herein by reference. The biomass can come from a number of sources, with municipal solid waste (MSW) being a commonly used feedstock. However, other feedstocks are possible including waste paper, waste cardboard, waste from food processing, waste from paper processing or other cellulose containing material, including any waste materials that include a pulpable biomass fraction, including biosolids. Processing the biomass in a reaction vessel results in a cellulosic material that is physically and chemically changed from the biomass feed stream. This material can be added to soil as a soil amendment or soil treatment, and acts as an organic additive to the soil. Many other agriculture related products are possible, and are further discussed below.

Poor soils are benefited by the addition of organic material because the organic material benefits the soil, allowing improved oxygenation and percolation of water due to increased permeability. By contrast, soil that is predominately clay is often less permeable and is lacking in organic content. Clay soil will absorb and retain less water, and has increased runoff from the surface of the soil, which carries away beneficial topsoil. Application of organic matter to the soil adds carbon, which promotes the growth of beneficial bacteria. In soil that has adequate carbon, as plants grow and demand more nutrients, the added organic matter can be used as plant food. Scientists have been researching the benefits of organic material for decades. They have found that plant deficiency diseases usually are less severe in soils that are high in organic matter. Increased organic content not only increases the vigor of the plants, but various soil microorganisms become more active in the presence of an abundance of organic matter. For example, certain kinds of fungi that live in decaying organic matter have been found to kill harmful nematodes. The presence of organic matter in soils also improves the structure and tilth in clay soils and improves the water holding capacity of sandy soils. Additionally, organic matter contains natural organic complexes that make micronutrients, such as zinc and iron, more available to plants. Nitrogen also becomes available to plants as a result of decomposition of organic matter in the soils. The nitrogen is available as nitrate or ammonium. Phosphate is another important soil compound that is made available to plants in the soil by the decomposition of organic matter.

Organic matter is particularly beneficial to two types of problem soils, one is sandy soils. A very sandy soil will grow very little plant life unless organic material of some type is added to it. Organic matter improves the texture of sandy soil by filling the spaces between the grains of sand. This increases the water holding and nutrient holding capacity of the soil, thereby holding both water and fertilizer where it is available to plants. In clay soil, organic matter increases the tilth of the soil. Tilth is the physical condition of soil as it related to tillage, ease of seedling emergence, and deep root penetration. A soil that drains well, does not crust, takes in water rapidly, facilitates aeration and does not make clods, is said to have good tilth. Good tilth is achievable in a clay soil by the addition of organic material. The organic matter added to clay builds soil particles, which physically separate clay particles from each other. More importantly, microorganisms that degrade organic matter produce byproducts that bind individual clay particles together into aggregates. Particle aggregation in the topsoil reduces crusting, increases the rate of water infiltration and reduces erosion and runoff.

The conversion of critical problems in the disposal of MSW, a high concentration of fibrous materials in MSW and the suitability of a properly processed fibrous product has a soil amendment and is the basis of this invention.

Paper and paperboard products constitute about thirty-six percent of a typical MSW waste stream, and are the largest constituent in MSW. Other contents of MSW include yard trimmings (12%), food scraps (11%), plastics (11%), metals (8%), rubber, leather and textiles (7%), glass (6%), wood (6%) and others (3%). The three largest waste streams of MSW, paper, yard trimmings and food scraps, together make up about fifty-eight percent of the contents of MSW. Each of these three contain carbon and carbohydrates in fibrous configurations. Some typical biomass yields in tests result in 65% of the MSW stream being biomass. These fibrous configurations can be broken down by heat, pressure and agitation to form a high carbon product, which is less fibrous, or which has less complex fibers, than the original products. This product has been found to be an excellent soil amendment, additive, conditioner or treatment. The product of the invention can be used as a fertilizer for crops, potting media for plants and as a soil conditioner in all kinds of soil. There is almost no soil that would not benefit from an increase in the organic content of the soil.

The soil amendment of the invention can also be utilized as a feedstock for compost operations. In composting, an appropriate mix of undigested cellulose, digested cellulose and nitrogen compounds are needed to achieve optimal bacterial reaction. The cellulosic material of the invention can be mixed with other ingredients to produce engineered materials for composting.

Although the soil amendment of the invention can be prepared from various biomass streams, the typical method of the invention utilizes steam at less than fifteen pounds to supply heat and pressure to the reaction vessel. This is typically maintained for approximately forty-five minutes, although longer and shorter times still fall within the concept of the invention as described in the claims.

The heat, pressure, and agitation that are supplied in the reaction vessel to the biomass stream result in reduced crystallinity of the biomass. It also can result in chemical reduction of the hemicellulose content to simpler derivatives of hemicellulose.

The invention also includes the method of making a soil additive from the biomass. The biomass would typically be from MSW, but other biomass streams are also suitable to this method. The method includes the steps of adding a quantity of the selected biomass to a reaction vessel that is configured for agitation of the materials. Agitation can be in the form of paddles, broken or continuous, that are affixed to the inside of the rotating reaction vessel. Typically, auger vanes mounted permanently on the inside of the reaction vessel will aid in agitating the biomass and moving it in one direction or the other. The next step is to close the reaction vessel, and begin rotation of the vessel. Next the vessel is purged of ambient air using injected steam while rotation continues. The vessel is then sealed and rotation continues or other agitation may be initiated while adding steam through one or more steam injection ports in the vessel. The pressure inside the vessel is intended to be less than 15 psi. The vessel is rotated and heated for approximately forty-five or more minutes while injecting steam through one or more injection inlets. The next step is to depressurize the vessel, which includes condensing the atmosphere from the vessel in a condensation unit to trap off gases and odors. The next step is to open the door of the reactor and move the treated biomass from the reaction vessel. This is typically accomplished by rotation of the reaction vessel and by action of auger vanes within the reaction vessel. The next step is separating the cellulosic fraction of the treated biomass from other fractions. Since the biomass can originate from MSW, other fractions can include aluminum and metal cans, glass, and plastic.

The reaction vessel utilized with this method is typically a cylindrical vessel, which has internally mounted auger flights or vanes that aid in agitation, physical destruction, and moving of the biomass inside the reaction vessel. One or more steam inlet lines may be utilized to add steam pressure and heat to the reaction vessel.

In one version of the process of making the soil additive of the invention, the steam and gases from inside the reaction vessel are evacuated through a barometric condenser before removing the treated biomass from the reaction vessel in order to reduce escaping emissions from the heated biomass.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a flow chart showing the processing of MSW to biomass for use as soil amendment.

FIG. 2 is a side view of a vessel suitable for processing MSW into a soil amendment.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In 2001, 229 million tons of MSW were generated. Of that quantity, the approximate breakdown of constituents is as follows:

| | |
|---|---|
| Paper | 35.7% |
| Yard Trimmings | 12.2% |
| Food Scraps | 11.4% |
| Plastics | 11.1% |
| Metals | 7.9% |
| Rubber, leather and textiles | 7.1% |
| Glass | 5.5% |
| Wood | 5.7% |
| Other | 3.4% |

In order to reduce the generation of MSW, the EPA has identified several strategies. The most preferred is source reduction, followed by recycling and composting. The least desirable ways to deal with MSW is combustion in combustion facilities and placement in landfills. Pyrolysis, also called plasma arc, is one method of combustion. It is a method that exposes material to temperatures of 10,000 degrees centigrade or higher. This chemically decomposes any organic matter present. CO and CO₂ are released in the process. A pyrolysis unit can be relatively small and can be mounted on a truck. The disadvantage is that this technology is very costly at present.

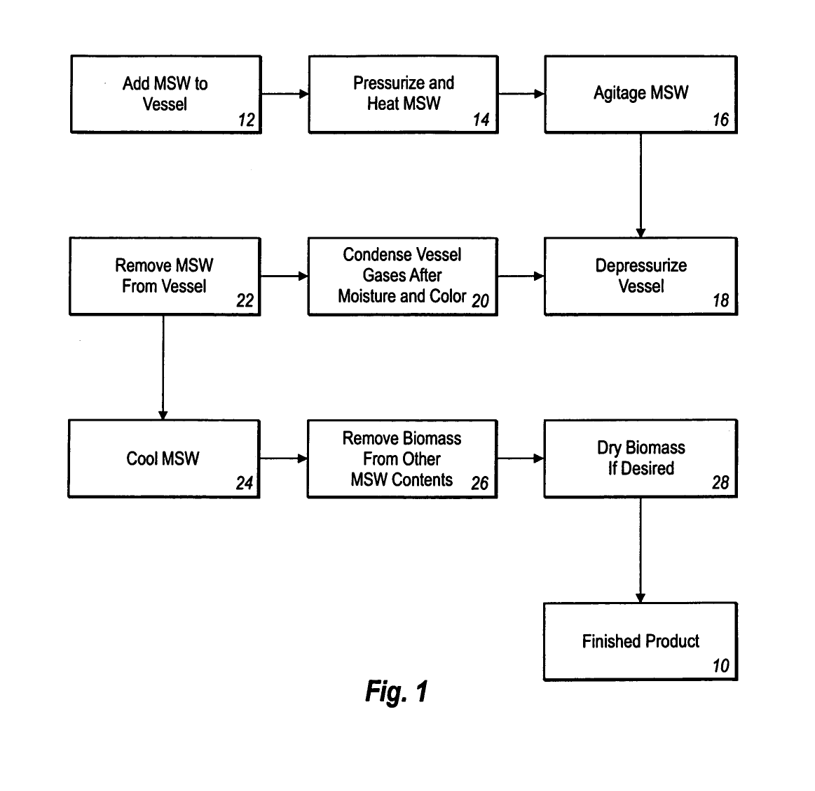

The present invention has the advantage of being a recycling method in that it separates the cellulose fiber portion of the waste and recycles it to a useful purpose. This is unusual in the waste recycling process, because recycling is usually referred to as recycling of metal products, glass and plastics. At present there is very little or no recycling of paper or cellulose fiber containing material from disposal bound waste, which make up the three largest waste streams found in MSW. The steps of this process are shown in FIG. 1.

The biomass would typically be from MSW, but other biomass streams are also suitable to this method. The preferred method includes the step at box 12 of adding a quantity of the selected biomass to a reaction vessel that is configured for agitation of the materials. Agitation is preferably in the form of paddles, broken or continuous, that are affixed to the inside of the rotating reaction vessel. Typically, auger vanes mounted permanently on the inside of the reaction vessel are used to aid in agitation of the biomass and moving it in one direction or the other. The next step is to close a reaction vessel and purge it of ambient air at the same time the vessel is rotated and other agitation is initiated while adding steam at fifteen pounds or less of pressure through one or more steam injection ports in the vessel, as shown in block 14. The vessel is rotated (block 16) and heated for approximately forty-five or more minutes while injecting steam through one or more injection inlets. The next step is to depressurize the vessel (block 18), which includes condensing the atmosphere from the vessel in a condensation unit to trap off gases and odors (block 20). The next step is to open the door of the reactor and move the treated biomass from the reaction vessel (block 22). This is typically accomplished by rotation of the reaction vessel and by action of auger vanes within the reaction vessel. Next, the treated biomass is cooled to a temperature selected for the next step in the process that is selected (block 24). The next step is separating the cellulosic fraction of the treated biomass from other fractions (block 26). The next step is typically to dry the biomass to the desired moisture level appropriate for the final use of the biomass, shown in block 28. The resultant finished product is shown at 10 or FIG. 1.

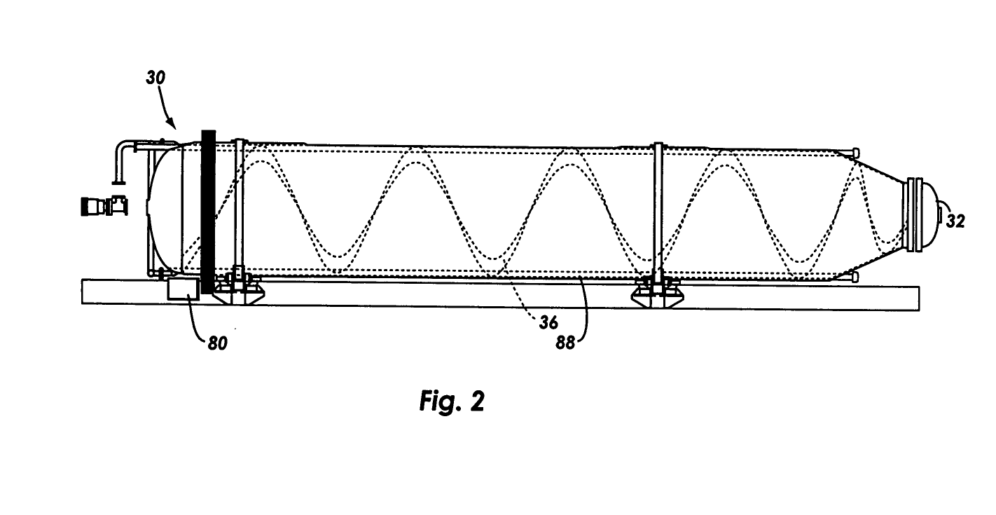

The preferred form of the invention is to place a quantity of MSW in a reaction vessel as shown in FIG. 2. The reaction vessel utilized with this method is typically a cylindrical vessel 30, which has internally mounted auger flights or vanes 36 that aid in agitation, physical destruction, and moving of the biomass inside the reaction vessel. Typically, one or more steam inlet lines 88 are utilized to add steam pressure and heat to the reaction vessel. The entire vessel is designed for rotation by a motor 80 with a door 32 at one end. A vessel similar to that disclosed in U.S. patent application Ser. No. 10/713,557 is suitable for this process, and is incorporated herein by reference.

The step shown at 20, of routing the steam and gases from inside the reaction vessel through a barometric condenser before removing the treated biomass from the reaction vessel serves the purpose of reducing emissions from the heated biomass, and is a desirable but optional step.

The product that results from treating MSW in such a vessel has a reduced particle size compared to the MSW from which it originated. This results partly from physical shredding, tearing, and pulping of all fiber materials, but more importantly from chemical change of the pulp and paper fractions within MSW. Thus the steam and pressure process produces a homogeneous cellulosic end product derived solely from the paper and pulp portion of MSW. The cellulosic biomass product thus formed is different in its basic molecular structure and chemical characteristic from the original MSW. It is a fluffy product, which when wet is somewhat like wet oatmeal. It has an increased surface area compared to the original fibrous portion of MSW. It also has a reduced fiber length and crystallinity of cellulose fibers compared to the MSW source. Additionally, the hemicellulosic content is lower in the cellulosic biomass than in the MSW from which it is derived. Any water soluble portions of the MSW are dissolved and largely removed.

The biomass material thus produced is useful in the fields of agriculture and horticulture in a variety of ways. As described above, the biomass can be added to problem soils such as clay or sandy soils, to improve the texture and tilth. Such an addition improves water retention, release of nutrients, decreases runoff, and contributes to general soil benefaction. This includes use as a soil agent stabilization.

The biomass of the invention can also be used as a hydroseeding carrier. Hyrdoseeding is a method of seeding in which a fibrous carrier is impregnated with seeds of a desired plant, such as grass. The impregnated carrier is sprayed on the area to be seeded, and covers the area. The carrier is typically sprayed on as a moist pulp, with the fibrous carrier providing sun protection and a moisture retaining matrix for the seeds. Using hydroseeding, the seeds can be in an optimized environment for germination, without the need to cultivate the soil to receive the seeds. The biomass of the invention can serve as the carrier for the hydroseeding process, and can even be produced at the preferred moisture content of the hydroseeding process.

The biomass of the invention can also be used in a potting mix. Potting mixes are sold in packages, such as plastic bags or cardboard boxes, and is also sold in bulk, by the pickup load, or delivered to a site. Such potting mixes are often mixed at a nursery, which blends several components, such as sand, fiber, compost, and aged manure. Other ingredients can include sphagnum, peat moss, vermiculite, perlite, and aged composted forest products or sand (see sidebar). Some of these components are added in order to add fiber to the mix, for water retention, for nutrient release, and to separate clay and sand particles. Such a mix of ingredients is called a soilless mix, and has the advantage that none of the ingredients contain soil borne contaminants, like mold spores, insect egss, nematodes, plant viruses, or plant disease bacteria. Such mixes encourage fast root growth.

The biomass of the invention provides an excellent addition to potting mixes, and contributes fiber and bulk, in a form that is free of plant pests such as nematodes, bacteria, and fungus spores. It can be mixed with other ingredients to form a soil-less potting mix, and replace the fiber and water retention components in the mix, such as sphagnum, peat moss, and forest products.

The biomass of the invention can serve as a daily cover at a landfill. As such it canned be spread or sprayed on the landfill to keep down dust and flies, erosion, birds and other vermin and blowing litter and odor. It can be mixed with a tacking agent or blended with other materials to aid in this role.

The biomass of the invention can be used as a bulking agent for soil mixes. For instance, if a quantity of biosolids from another process is to be disposed of by adding to soil or mixing with soil, it may have 10% solids and 90% liquids. The biomass of the invention can be added to such a product, and absorb the liquid until no liquid flows from the mix. This mix would be able to pass a paint filter test. The paint filter test is a test for free liquids in a representative sample of waste, and is an official method for determining compliance with 40 CFR 264.314 and 265.314. The product of the invention could be used as a soil stabilizer, and as an engineered bio-fertilizer tablet.

An analysis of product exiting a reaction vessel after heat, pressure and agitation shows the following composition:

| Method | Parameter | Result | Units |
|---|---|---|---|
| EPA 160.4 | Organic Matter (550 C.) | 74.1 | % |
| EPA/CE-81-1 | Total Nitrogen (N) | 11000 | mg/Kg |
| EPA/CE-81-1 | Phosphorus, Total (P) | 2678 | mg/Kg |
| EPA 7610 | Potassium (K) | 2590 | mg/Kg |
| EPA 7130 | Cadmium (Cd) | 2 d | mg/Kg |
| EPA 7210 | Copper (Cu) | 75 | mg/Kg |
| EPA 7420 | Lead (Pb) | 118 | mg/Kg |
| EPA 7520 | Nickel (Ni) | 66 | mg/Kg |
| EPA 7950 | Zinc (Zn) | 722 | mg/Kg |
| Screen Test | Foreign Matter, Retained | 22.59 | % |
| | on ¼″ Screen | | |
| Screen Test | Bones, % of total compost | 0 | % |
| Screen Test | Glass, % of total compost | 22.57 | % |
| Screen Test | Leather, % of total compost | 0 | % |
| Screen Test | Metal, % of total compost | 12.87 | % |
| Screen Test | Plastic, % of total compost | 1.76 | % |
| Screen Test | Rubber, % of total compost | 0 | % |
| Screen Test | Other, % of total compost | 62.80 | % |
| Screen Test | Foreign Matter, Retained | 22.96 | % |
| | on ¼″ Screen | | |
| Screen Test | Bones, % of total compost | 0 | % |
| Screen Test | Glass, % of total compost | 23.00 | % |
| Screen Test | Leather, % of total compost | 0 | % |
| Screen Test | Metal, % of total compost | 1.40 | % |
| Screen Test | Plastic, % of total compost | 2.26 | % |
| Screen Test | Rubber, % of total compost | 0 | % |
| Screen Test | Other, % of total compost | 73.34 | % |
| SM9221E | Fecal Coliform (MPN)/gm. | >160 | |
| | Dry Weight | | |
| SM9221E | Date and time started | 0826 1330 | |
| SM9221E | Fecal Coliform (MPN)/gm. | >160 | |
| | Dry Weight | | |
| SM9221E | Date and time started | 0826 1330 | |

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A soil amendment comprising:
cellulosic pulp derived from biomass processed in a reaction vessel in the presence of heat and pressure, in which the biomass is subjected to agitation caused by rotation of the vessel.

2. The soil amendment of claim 1, in which the heat and pressure is in the form of steam at 15 pounds or less of pressure applied to the contents of the reaction vessel.

3. A soil amendment comprising:
cellulosic pulp derived from biomass processed in a reaction vessel in the presence of heat and less than 15 pounds or less of pressure, in which the biomass is subjected to agitation caused by rotation of the vessel.

4. The soil amendment of claim 1, in which the biomass stream is from MSW.

5. A soil amendment comprising:
cellulosic pulp derived from MSW biomass processed in a reaction vessel in the presence of heat and less than 15 pounds or less of pressure, in which the biomass is subjected to agitation caused by rotation of the vessel.

6. The soil amendment of claim 5, in which said cellulosic pulp has a reduced crystallinity of cellulose compared to the original MSW biomass from which it is derived.

7. The soil amendment of claim 5, in which said heat and pressure and agitation are sufficient to reduce the crystallinity of cellulose of said biomass.

8. The soil amendment of claim 5 in which said cellulosic pulp has a reduced crystallinity of hemicellulose compared to the original MSW biomass from which it is derived.

9. The soil amendment of claim 5, in which said heat, pressure and agitation are sufficient to chemically reduce the hemicellulosic content of said biomass to compounds chemically less complex than hemicellulose.

10. A soil amendment comprising:
cellulosic pulp derived from biomass processed in a reaction vessel in the presence of heat and pressure in the form of steam at 15 pounds or less of pressure applied to the contents of the reaction vessel for approximately 45 minutes, which combined with agitation caused by rotation of the vessel creates an environment sufficient to reduce crystallinity of cellulose of said biomass, and to chemically reduce hemicellulosic in said BIOMASS to compounds chemically less complex than hemicellulose.

11. A method for creating a soil additive from the cellulosic fraction of biomass, which comprises the steps of:
adding biomass to a sealable reaction vessel configured for agitation of said biomass;
closing said reaction vessel;
rotating said reaction vessel while adding steam at 15 pounds or less to said reaction vessel;
unsealing the reaction vessel, and removing the treated biomass from the reaction vessel; and
separating the cellulosic fraction of the treated biomass from other fractions of the treated biomass.

12. The method for creating a soil additive from the cellulosic fraction of biomass of claim 11, which further includes the step of agitating the biomass in the reaction chamber by rotation of the reaction vessel and by action of auger vanes within said reaction vessel.

13. The method for creating a soil additive from the cellulosic fraction of biomass of claim 11, which includes the step of providing a reaction chamber with an access door at one end, with a door cover which may be sealed on said access door during the heating and pressure step, and unsealed from said access door for input and removal of biomass.

14. The method for creating a soil additive from the cellulosic fraction of biomass of claim 11, which further includes the step of cooling the treated biomass after removal from the reactor.

15. The method for creating a soil additive from the cellulosic fraction of biomass of claim 11, which further includes the step of providing a condensation chamber for said reaction vessel, in which gases from said reaction chamber may be routed and condensed to remove odors and off gas before the biomass is discharged from the reaction vessel.

16. The method for creating a soil additive from the cellulosic fraction of biomass of claim 11, which further includes the step of rotating the reaction vessel and heating the biomass for approximately 45 or more minutes by injecting steam into the reaction vessel.

17. The method for creating a soil additive of claim 11, which includes the step of adding said biomass to a generally cylindrical reaction vessel with internal auger flights for agitation and moving of said biomass.
